(19) United States
(12) Patent Application Publication
(10) Pub. No.: US 2015/0021332 A1
(43) Pub. Date: Jan. 22, 2015

(54) Pet Waste Station

(71) Applicant: Carole Autumn, Fort Worth, TX (US)

(72) Inventor: Carole Autumn, Fort Worth, TX (US)

(21) Appl. No.: 13/948,121

(22) Filed: Jul. 22, 2013

(51) Int. Cl. B65F 1/06; B65F 1/14

(52) U.S. Cl. CPC B65F 1/06; B65F 1/163
USPC 220/495.08

(57) ABSTRACT

This invention relates to a container for pet waste. The container includes an inner member that is removable from an outer member. The container has a lid composed of an inner section surrounded by an outer section. The inner section is hingedly connected independently of the outer section.

This patent claims the benefit of provisional patent application number 61674307.

### FIELD OF THE INVENTION

This invention relates to the containers, and more particularly, to a receptacle for storage of pet wastes.

### DESCRIPTION OF PRIOR ART

A number of systems have been devised for the purpose of collecting and storing pet waste. Many municipalities make pet owners responsible for picking up animal waste caused by the owner's pet. The system keeps bacteria and organisms from touching human hands and is inexpensive and economical to use.

The present invention is a new pet collection receptacle design that is not disclosed in the prior art.

### OBJECTS OF THE INVENTION

It is an object of the present invention, therefore, to provide a new and improved alternative to prior methods of disposing pet wastes.

It is another object of the invention to provide an alternative to methods of disposing pet wastes that create household odors.

It is a further object of the invention to provide such an alternative method of disposing pet wastes which is inexpensive to manufacture and simple to utilize.

### SUMMARY OF THE INVENTION

The present invention entails a receptacle for feces, urine, and other pet wastes by utilizing a cylindrical container for storage until final disposition of the waste will be made. The storage container also stores bags for placement of the pet wastes. The pet wastes are placed in a bag which is then placed in the storage container which makes for easy removal of the pet wastes for final disposition. The storage container has the twist and lock sealing feature on the lid. There is a small lid attached to the main lid which is activated by depression of a foot pedal. This allows the user to place a bag with pet waste into the container but minimizes odor from escaping the container. The storage container also has two smaller containment units attached. One unit is for storage of the waste bags, and the other unit is for storage of sanitation wipes.

### BRIEF DESCRIPTION OF THE DRAWINGS

These and other features of the present invention will be more clearly understood from a consideration of the following description, taken in connection with the accompanying drawings, in which:

FIG. 1 is a front perspective view of the pet waste receptacle.

FIG. 2 is a cross-sectional view of the pet waste receptacle with inner lid opened.

FIG. 2a is a front plan view of the pet waste receptacle with inner lid opened.

FIG. 2b is a cross-sectional view of the pet waste receptacle with inner lid closed.

FIG. 2c is a front plan view of the pet waste receptacle with inner lid closed.

FIG. 3 is an exploded view of the container.

FIG. 4 is a bottom cutaway view of the lid.

FIG. 5 is a top view of the container.

FIG. 6 is a top view of the container with the inner member raised.

FIG. 7 is a cutaway view of inner member removed.

FIG. 8 is a bottom view of the lid.

### DETAILED DESCRIPTION

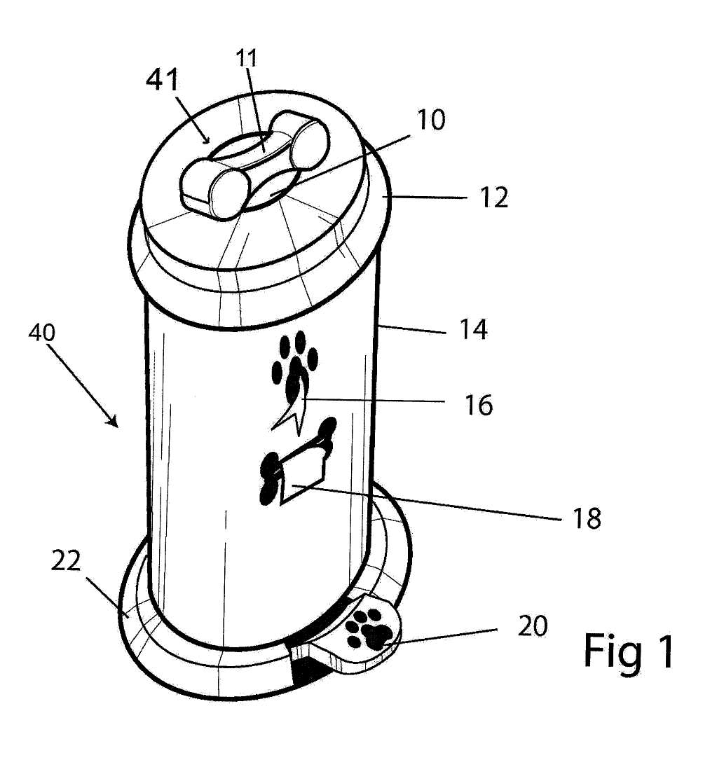

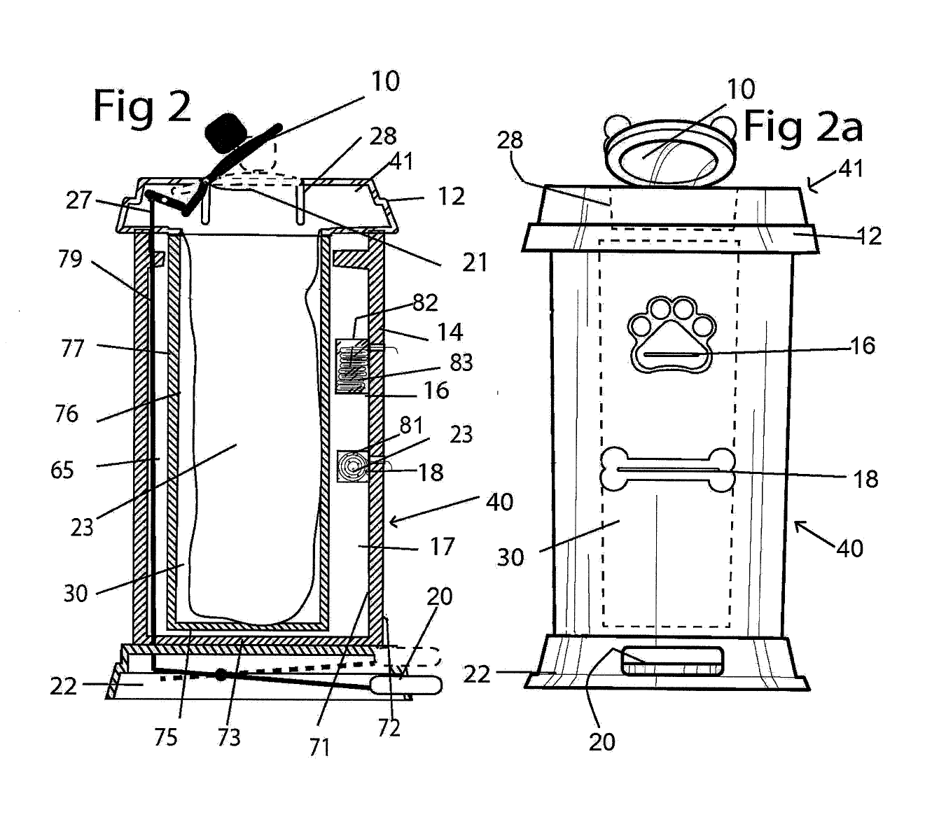

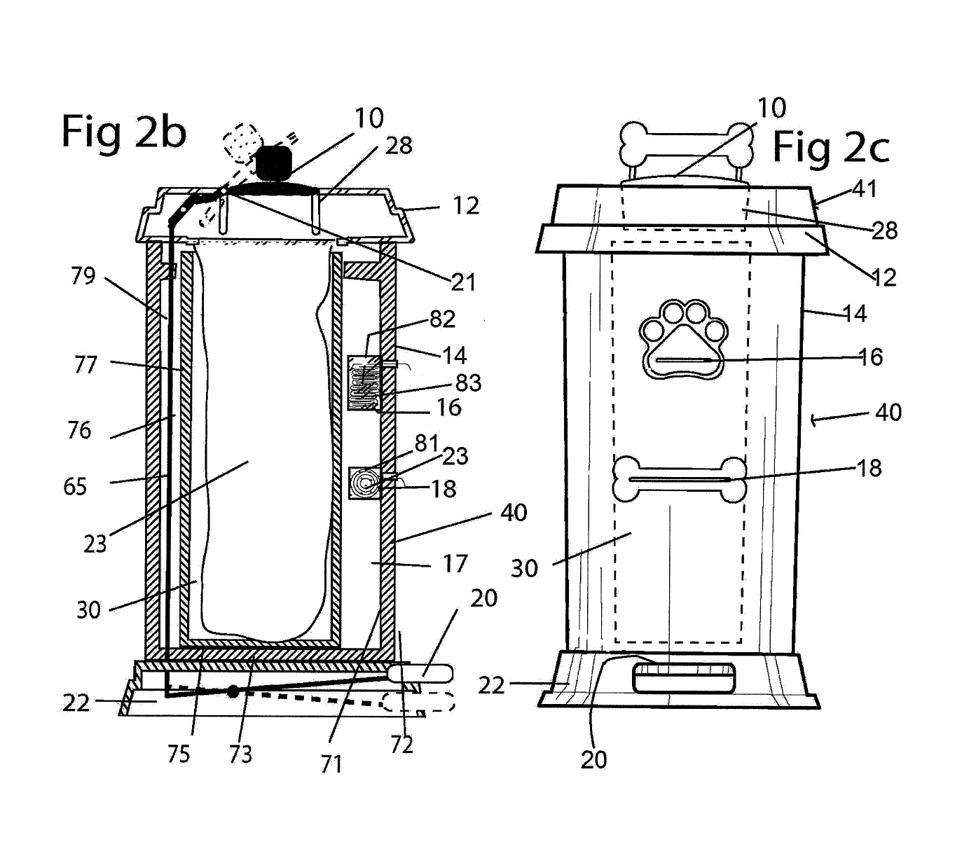

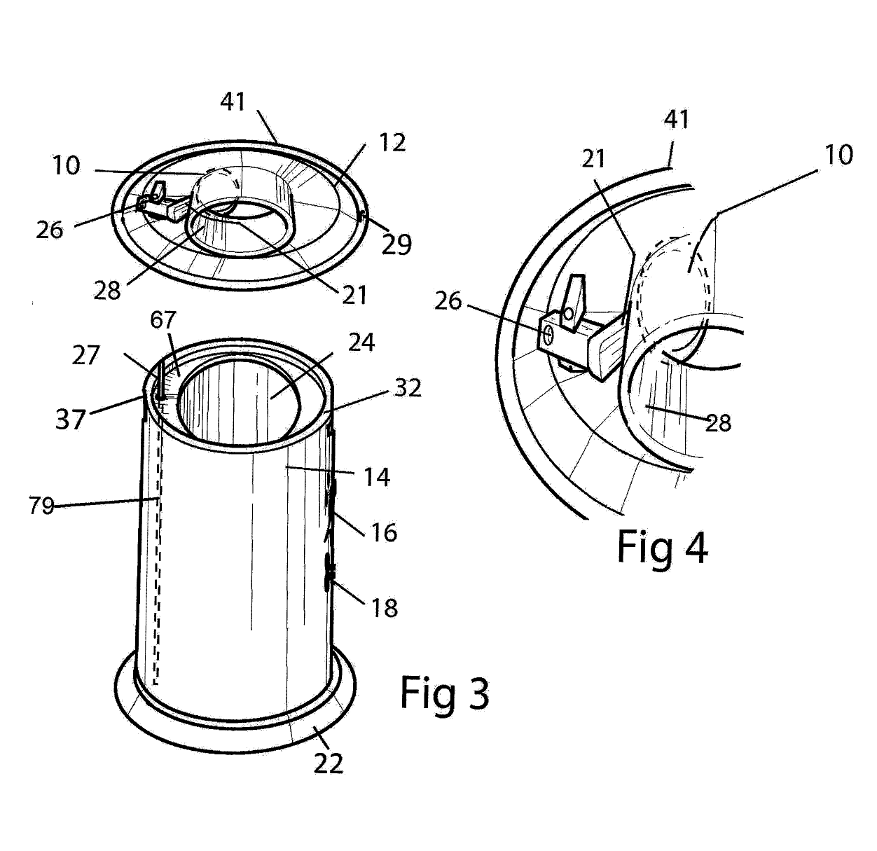

Referring to FIG. 1, there is shown a perspective view of the present invention, pet waste station (40). FIG. 2 is a cross-sectional view of the pet waste station (40). The present invention, pet waste station (40), comprises a container with an outer member (14) that has a removable inner member (30) therein. The outer member (14) includes a base (22) with attached surrounding side walls extending linearly upward to an opened upper end forming an upper rim (32) as shown in FIG. 3. Surrounding side walls of outer member (14) further comprises an interior surface (71) and exterior surface (72). Outer member (14) includes a bottom wall (73) interiorly disposed upon the base (22) as shown in FIG. 2. The outer member (14) further comprises a collar (67) with an inner opening dimensioned to receive the inner member (30) therethrough and attached to the upper rim of outer member (14) thereto. Collar (67) forms a guide that can be used to hold inner member (30) steadily in place. In an alternative embodiment a sleeve (68) with a sufficient diameter can be incorporated within base (22) of outer member (40) to hold inner member (30) therein as shown in FIGS. 2a and 2c.

The inner member (30) includes a bottom wall (75) with attached surrounding side walls extending linearly upward to an opened upper end (33) wherein an inner compartment (24) is formed therein. Surrounding side walls of inner member (30) further comprises an interior surface (76) and an exterior surface (77). When inner member (30) is placed within outer member (14) front interior cavity (17) is formed and rear inner cavity (65) are formed therein.

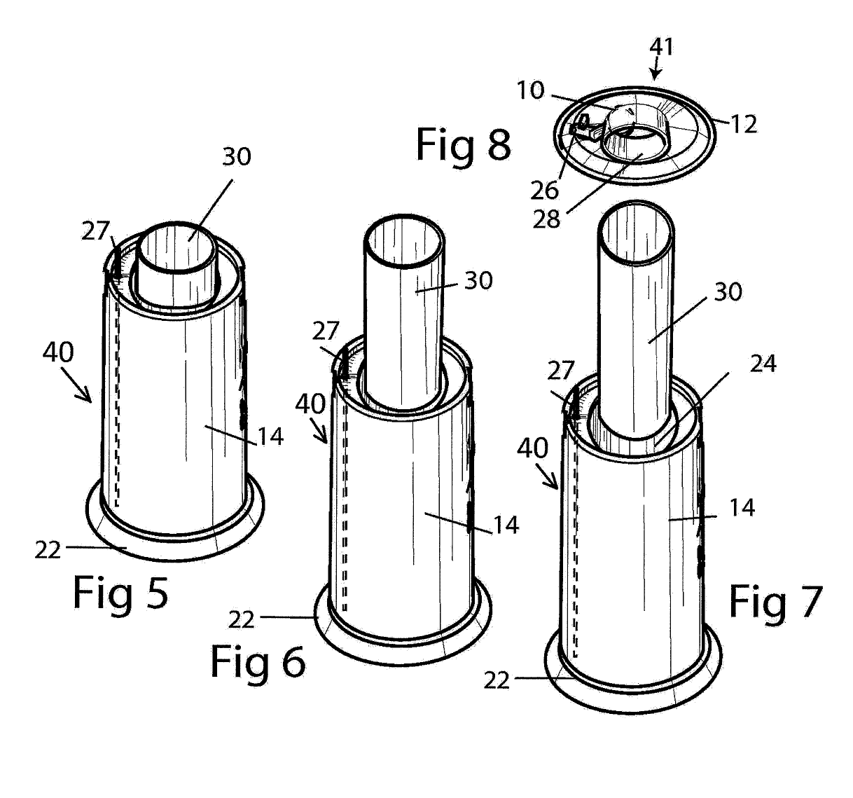

Referring to FIGS. 5, 6, 7 and 8 the inner member (30) has a slightly smaller diameter than the outer member (14) wherein an inner cavity (17) is formed therebetween. In the preferred embodiment, the inner member (30) is removable from the outer member (14). In the preferred embodiment, the inner member (30) and outer member (14) are cylindrical in shape, but their embodiments are not limited to that shape.

Referring to FIGS. 2 and 3, The present invention further includes a bag member (23) extending the length of the inner cavity (24) of the inner member (30) and is mounted therein with the upper end of the bag member (23) attached to the upper end of the inner member (30). As shown in FIG. 2, the bag member (23) has a mouth opening into a body which defines the interior of the bag member (23). The body of the bag member (23) has an interior surface and an exterior surface. The bag mouth is attached to the upper end of the inner member (30). The bag member (23) is utilized to store individual bags (93) filled with pet waste until it can be disposed of.

Referring to FIG. 3, the present invention further comprises a lid (41) having an inner section (10) surrounded by an outer section (12). In one embodiment, a locking member (26) is attached to the underside of the outer section (12) of lid (41). A mating attaching member (27) is attached beneath the locking member (26) and mounted to upper end of the outer member (14). In use, the attaching member (27) which is the top of rod (79) is operationally engaged with locking member (26). As shown in FIG. 2, 2b, 2c, and FIG. 3. When lid (41) is securely engaged with the upper end of outer member (14) it helps to keep the odor contained therein. As shown a FIG. 3, a plurality of fastening elements (29) surrounds the underside of the peripheral edge of outer section (12) of lid (41). Mating notches (37) are disposed upon the upper end of outer member (14) wherein the fastening elements (29) form a secured seal when connected to notches (37).

Referring to FIGS. 3 and 4, the inner section (10) of the lid (41) is hingedly attached to outer section (12) allowing the inner section (10) to be opened and closed easily and independently of the entire lid (41). As shown in FIG. 2, inner section 10 has a hinged connection (21). A foot pedal actuator (20) being disposed within the base (22) of the container is operationally connected to the inner section (10) of the lid (41) through back cavity (65). As shown an elongated rod (79) is placed beneath the attaching member (27) extending downward within the inner compartment (65) to the bottom wall (75) of the outer member (14) and extending perpendicular to the foot pedal actuator (20) wherein the rod (79) is cooperatively engaged with the foot pedal actuator to allow the uplifting of inner section (10) of lid (41) Referring to FIGS. 2, 2a, 2b,3, and 4 in use, when the foot pedal actuator (20) is pressed the inner section (10) of lid (41) is raised up from the outer section (12). When the foot pedal actuator (20) is released the inner section (10) of lid (41) is lowered downward into the outer section (12) of lid (41). In use, when foot pedal actuator (20) is pressed downward, rod (79) is extended upward causing attaching member (27) to engage within locking member (26) wherein inner section (10) is raised upward. In alternative embodiment, lid (41) can further comprise a chute (28) with a diameter substantially equivalent to inner section (10) and extends downward to inner member (30). In some embodiments handle (11) can be attached atop lid (41) and be configured into an aesthetically pleasing shaped such as a bone as depicted in FIG. 1.

The present invention further comprises a sanitary dispenser (16) container mounted to inner wall within the front section of the inner compartment (17). In alternative embodiments bag dispenser (18) and sanitary dispenser (16) can be mounted within interior compartment (17). Bag dispenser (18) container mounted to the interior surface (71) within the front section of the inner compartment (17) below the sanitary dispenser (16) within the inner compartment (17). As shown in FIGS. 2 and 2b, bag dispenser (18) includes and an aperture extending through the exterior surface (72) of the surrounding wall of outer member (14) into the interior cavity of the holder member (81) of bag member (23). As shown in FIGS. 2 and 2b, holder member (81) is securely mounted to the interior surface 71 of surrounding walls of outer member (14) within front interior compartment (17). As shown in FIG. 2, sanitary dispenser (16) includes and an aperture extending through the exterior surface (72) of the surrounding wall of outer member (14) into the interior cavity of the holder member (82) of wipes (83). As shown in FIG. 2, holder member (82) is securely mounted to the interior surface 71 of surrounding walls of outer member (14). In the illustrated embodiment, for dispensing, a first opening is located directly above a second opening for dispensing bag member 23 and wipes (83). Additionally, animal specific indicia can be incorporated upon the external surface area (72) of the surrounding sidewall of outer member (14) near the first opening and the second opening as shown in FIG. 1.

1. A pet waste receptacle comprising:
a container comprising an inner member securely disposed within an outer member wherein a surrounding interior chamber is formed therebetween;
a base disposed underneath the container supporting the container in an upright position;
the outer member comprising an outer bottom wall attached to a surrounding outer sidewall extending linearly upward to an opened upper end surrounded by an outer rim;
the inner member comprising an inner bottom wall attached to a surrounding inner sidewall extending linearly upward to an opened upper end surrounded by an inner rim;
the outer sidewall defined by an exterior surface area and an interior surface area;
the inner sidewall defined by an exterior surface area and an interior surface area;
the interior chamber defined by a front section and a rear section;
the front section disposed between the interior surface area of the outer side wall and the exterior surface of the inner side wall of the front section of the interior chamber;
the rear section disposed between the interior surface area of the outer side wall and the exterior surface of the inner side wall of the rear section of the interior chamber;
a lid defined by an inner section surrounded by an outer section;
an attaching element interconnecting the outer section to the inner section wherein the inner section traverses between an opened and closed position independently from the outer section;
a plurality of fastening members circumferentially surrounding an underside of a peripheral edge of the outer section of the lid;
a plurality of complementary attaching elements circumferentially surrounding the outer rim wherein the plurality of fastening members securely and operationally connects to the plurality of complementary attaching elements wherein any odor is contained within the inner member of the container therein;
when opened the inner section allows exclusive access to the inner member.

2. The receptacle of claim 1 further comprising a foot pedal mounted within the base and operationally connected to the attaching element through the interior chamber.

3. The receptacle of claim 2 wherein the foot pedal is operationally connected through the rear section of the interior chamber.

4. The receptacle of claim 1 further comprising:
a bag member having a mouth extending into a body; and
the mouth extending over the inner rim and the body extending into the inner member.

5. The receptacle of claim 1 further comprising:
a bag container having a compartment defined by a length, width and depth configured to hold a plurality of bags;
a peripheral edge circumferentially surrounding the compartment; and
the peripheral edge mounted to a portion of the interior surface area of the outer side wall member within the interior cavity over a first aperture extending through the outer side wall into the compartment.

6. The receptacle of claim 1 further comprising:
a wipe container having a compartment defined by a length, width and depth configured to hold a plurality of wipes;
a peripheral edge circumferentially surrounding the compartment; and
the peripheral edge mounted to a portion of the interior surface area of the outer side wall member within the interior cavity over a second aperture extending through the outer side wall into the compartment.

7. The receptacle of claim 6 further comprising the bag container disposed directly above the wipe container.

8. The receptacle of claim 4 wherein the bag member being removable disposed within the interior chamber of the inner container.

9. The receptacle of claim 1 further comprising an L shape rod disposed within the base and extending linearly upward through the rear section of the interior chamber.

10. The receptacle of claim 1 wherein the base further comprises a compartment within the bottom wall for receiving the inner member therein.

11. The receptacle of claim 1 wherein the lid further comprises a chute mounted underneath the inner section of the lid directly above the inner member with a diameter substantially equivalent to the inner member.

12. The receptacle of claim 1 wherein the inner member is removable from the outer member.

13. The receptacle of claim 1 wherein the attaching element forms a hinged connection between the inner section and the outer section of the lid.

14. The receptacle of claim 1 wherein the lid further comprises a handle mounted atop thereon.

15. The receptacle of claim 14 wherein the handle has a bone shape.

16. The receptacle of claim 1 wherein the lid is removable.
